(19) United States
(12) Patent Application Publication
(10) Pub. No.: US 2005/0238288 A1
(43) Pub. Date: Oct. 27, 2005

(54) Method and apparatus for resonantly driving plasmon oscillations on nanowires

(75) Inventor: William Y. Crutchfield, Pleasanton, CA (US)

Correspondence Address: FULBRIGHT & JAWORSKI, LLP, 666 FIFTH AVE, NEW YORK, NY, 10103-3198, US

(73) Assignee: Plain Sight Systems, Inc.

(21) Appl. No.: 11/093,081

(22) Filed: Mar. 28, 2005

Related U.S. Application Data
(60) Provisional application No. 60/556,850, filed on Mar. 26, 2004.

(51) Int. Cl. G02B 6/26

(52) U.S. Cl. 385/50

(57) ABSTRACT

Method and apparatus for resonantly driving a nanowire waveguide a dielectric waveguide core placed close to the nanowire waveguide, so that energy couples from the dielectric waveguide to the nanowire waveguide. The resonant coupling can be achieved by selecting the dielectric waveguide and the nanowire to support modes having substantially the same frequency ω and same longitudinal propagation constant β.

### RELATED APPLICATION

This application claims priority benefit under Title 35, U.S.C. § 119(e) of provisional application No. 60/556,850, filed Mar. 26, 2004, which is incorporated by reference in its entirety.

### FIELD OF THE INVENTION

The present invention is directed to the field of electric fields in Raman spectrography, and more particularly to extracting electromagnetic energy from a dielectric waveguide onto a nanowire.

### BACKGROUND OF THE INVENTION

There are many applications where it would be advantageous to be able to produce very intense electric fields at high optical or infra-red frequencies, including, for example: second harmonic generation, third harmonic generation, parametric oscillation and amplification, intensity-dependent refractive index, saturable absorption, Brillouin scattering and Raman scattering.

Many schemes are currently used to achieve high fields but none are completely satisfactory. For example, a lens can be used to concentrate the energy of a laser into a region of volume λ³. However, the active volume is small which limits the accumulation of non-linear effects. The creation of intense electric fields in a hollow core photonic crystal fiber (HC-PCF) has been demonstrated. See F. Benabid, J. C. Knight, G. Antonopoulos, P. St. J. Russel, (200), “Stimulated Raman Scattering in Hydrogen-Filled Hollow-Core Photonic Crystal Fiber”, Science 298, 399-402. The active volume can be large in a long length of fiber, but it is difficult to introduce samples into the hollow core of the fiber.

It is common to create intense electric fields for the purpose of Raman spectrography by exciting plasmon oscillations on the surface of metallic nanoparticles, such as surface enhanced Raman spectroscopy —SERS. See G. C. Schatz, R. P. Van Duyne (200) “Electromagnetic Mechanism of Surface-enhanced Spectroscopy”, in Handbook of Vibrational Spectroscopy, Vol. I J. Chalmers and P. R. Griffiths (ed). However individual nanoparticles intercept only a very small part of an incident light beam which limits the electric field intensity.

Fiber optic waveguides generate intense electric fields in their interiors. However, the exterior field is considerably less intense. Therefore, it is desirable to provide a system which extracts and concentrates the electric field in a region which is accessible for use.

### SUMMARY OF THE INVENTION

Embodiments of the present invention extract electromagnetic energy from a dielectric waveguide onto a nearby nanowire in a novel and non-obvious manner. In particular, for example, the coupling of the dielectric waveguide to a metallic nanowire extracts and concentrates the electric field in a region which is accessible for use, such as for Raman spectroscopy.

In accordance with an embodiment of the present invention, a nanowire can be resonantly driven by a bare dielectric waveguide core placed close to the nanowire, so that energy couples from the dielectric waveguide to the nanowire. In accordance with an aspect of the present invention, resonant coupling is achieved by choosing the dielectric waveguide and the nanowire to support modes having very nearly the same frequency ω, and same longitudinal propagation constant β.

Nanowires, preferably metallic nanowires, support modes called surface plasmon modes which are excitations producing very intense electric fields. When the dielectric waveguide and a metallic nanowire are resonantly coupled together, electromagnetic energy is coupled to plasmon modes with their intense electric fields.

These modes have the advantages that: the electric fields are even more intense than the original fields of the dielectric waveguide, the electric fields are most intense in a region which is accessible and the electric fields are not intensified within the dielectric waveguide, which can be advantageous in some applications where fields in the dielectric waveguide produce an undesirable background signal.

In accordance with an embodiment of the present invention, the Raman spectroscopy comprises a dual-waveguide system which resonantly drives plasmon oscillations on a nanowire to provide an accessible intense electric field.

The Raman spectroscopy as aforesaid can be used to detect and/analysis chemicals.

Various other objects, advantages and features of the present invention will become readily apparent form ensuing detailed description, and the novel features will be particularly pointed out in the appended claims.

### BRIEF DESCRIPT OF THE DRAWINGS

The following detailed description, given by way of example, and not intended to limit the present invention solely thereto, will be best understood in conjunction with the accompanying drawings in which:

FIG. 1 illustrates a block diagram of a Raman spectroscopy system in accordance with an embodiment of the present invention;

FIG. 2 is a cross-sectional diagram of a dual-waveguide system in accordance with an embodiment of the present invention;

FIG. 3 is a side view of the coupling between a dielectric waveguide and a nanowire waveguide of the dual-waveguide system in accordance with an embodiment of the present invention;

FIG. 4 is a diagram of a dual-waveguide system in accordance with an embodiment of the present invention wherein the waveguides cross at an angle;

FIG. 5 is a z component of the electric field for mode 11 of the dual-core system in accordance with an embodiment of the present invention;

FIG. 6 is an exemplary chart of the power of the forward scattered field as a function of z in accordance with an embodiment of the present invention;

FIG. 7 is an exemplary chart of the maximum magnitude of the electric field inside and outside the dielectric waveguide in accordance with an embodiment of the present invention;

FIG. 8 is an exemplary chart of the effective area of the active non-linear region as a function of z in accordance with an embodiment of the present invention;

FIG. 9 is an exemplary chart of the modal powers from the sample as a function of position in accordance with an embodiment of the present invention;

FIG. 10 is an exemplary chart of the modal powers from the dielectric waveguide as a function of position in accordance with an embodiment of the present invention;

FIG. 11 is an exemplary chart of the dispersion curves of the silver nanowires in accordance with an embodiment of the present invention;

FIG. 12 is a diagram of a dual-waveguide system in accordance with an embodiment of the present invention wherein the dielectric waveguide is enclosed by a nanowire waveguide.

### DETAILED DESCRIPTION OF THE EMBODIMENT

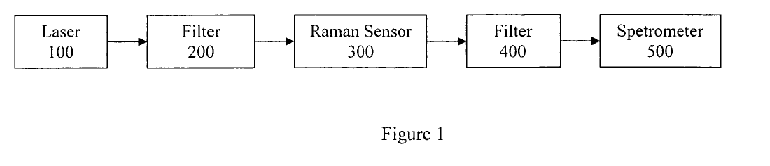

Turning now to FIG. 1 there is illustrated a block diagram of a Raman spectroscopy system 10 in accordance with an embodiment of the present invention. The Raman spectroscopy system 10 comprises a laser 100, a first filter 200, a Raman sensor 300, a second filter 400, and a spectrometer 500. In accordance with an aspect of the present invention, the Raman sensor 300 is used to generate intense optical fields. Typically the Raman sensor consists of a lens to concentrate the laser light to a spot with volume of order λ³. There are many possible applications and many possible realizations of the geometry. For example, in Raman scattering, embodiments of the invention can be used to create intense electric fields which then generate Raman scattered light from a sample. The scattered light can then be analyzed to determine the composition of the sample.

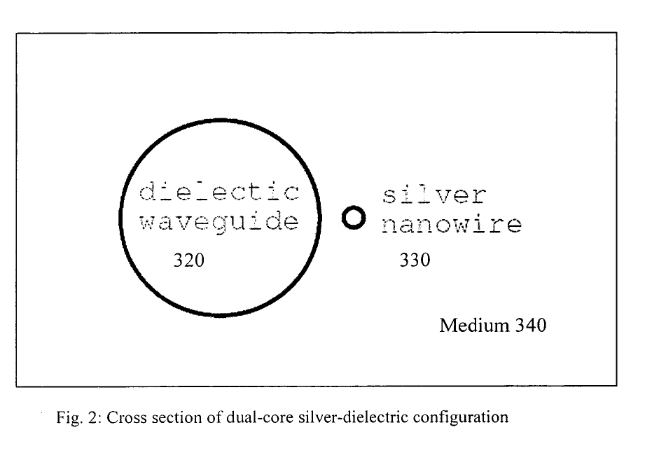

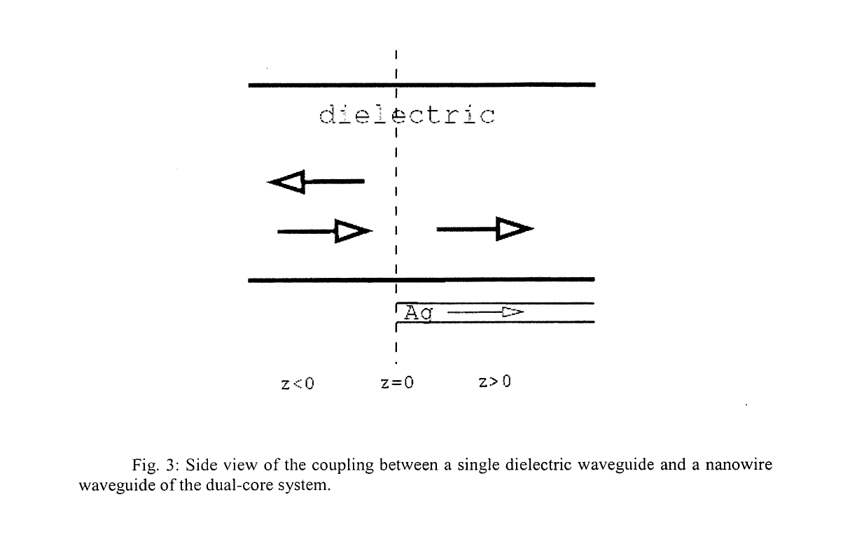

In accordance with an exemplary embodiment of the present invention, FIGS. 2 and 3 illustrate a novel Raman sensor 300 utilized with parallel waveguides. The Raman sensor 300 comprises a dual-core or dual-waveguide system 310 comprising a transparent dielectric waveguide 320 and a nanowire 330, preferably a metallic nanowire 330. Laser 100 propagates through the first filter 200 before entering the dielectric waveguide 320 of the Raman sensor 300. It is appreciated that most of the laser light continues on through the combined dielectric/nanowire dual-core system 310. A small part of the laser light is reflected back along the dielectric waveguide 320. A dielectric waveguide 320 is provided which is driven at one end by a laser 100 operating at an angular frequency co. The nanowire 330 is typically several hundreds of microns long. In accordance with an embodiment of the present invention, the nanowire 330 is a nanowire that supports plasmon excitations in the frequency range of interest, such as silver, gold, copper and the like.

In accordance with an exemplary embodiment of the present invention, the dielectric waveguide 320 and the metallic nanowire 330 are embedded in an external medium 340, e.g., a liquid in which Raman-active chemicals are present.

The dielectric waveguide 320 and the nanowire 330 each have propagating modes when considered separately from each other. In the present example, the size and the shape of the dielectric waveguide 320 and the metallic nanowire or waveguide 330 can be adjusted so that at the laser frequency ω, the two waveguides 320, 330 have a mode with nearly the same longitudinal propagation constant β. The two waveguides 320, 330 preferably do not have exactly the same β, since the β of the dielectric waveguide 320 is almost purely real, while the β of the metallic nanowire 330 generally includes a substantial imaginary part. The following condition should be satisfied to maximize the coupling of the dielectric waveguide 320 to the nanowire waveguide 330:
|Re(β_{dieletric}˜β_{nanowire})|<Im(β_{nanowire}) (1)

As shown in FIGS. 2 and 3, in accordance with an embodiment of the present invention, the two waveguides (i.e., the dielectric waveguide 320 and the nanowire 330) are positioned parallel to one another. FIG. 3 shows the two parallel waveguides 320, 330 in plan view. FIG. 2 illustrates the cross-section in the region where the two waveguides 320, 330 overlap. It is appreciated that the circular cross-section of the two waveguides 320, 330 is not necessary, although the circular cross-section is convenient if the dual-waveguide system 310 is attached to fiber optics, for example. However, if the dual-waveguide system is constructed using lithographic techniques, the cross-section of the waveguides 320, 330 will not be generally circular.

In accordance with an embodiment of the present invention, the dielectric waveguide 320 is separated from the metallic waveguide 330 by some distance d. The distance d can be chosen to optimize the operation of the dual-waveguide system 310 for a particular application. As d is decreased, the electric fields surrounding the metallic nanowire 330 become more intense, but the decay length of the modes also typically decreases. The exact evolution of the electric fields in the dual-waveguide system 310 may then be calculated for distance d, and accordingly optimized for a given application, e.g., Raman spectroscopy.

In a Raman application, one end of the dielectric waveguide 320 can be attached to an apparatus which measures Raman-scattered light. This can typically include filters (for example, filters 200, 400) to remove undesirable frequencies, and a grating or some other type of spectrometer 500.

In some applications, the dual-waveguide system or device 310 requires temperature stabilization to maintain the resonant coupling condition. This is because temperature variations can create changes in the refractive index of the materials of the device 310, which then causes the longitudinal propagation constants β to change. Such cooling can be accomplished by active cooling or active heating, i.e., refrigeration or heating coils. It is appreciated that temperature adjustments can be used to maintain the resonant condition in the presence of fabrication irregularities.

Turning flow to FIG. 3, there is illustrated a side view of the coupling between a single dielectric waveguide 320 and a nanowire 330, laser light is incident from the left through the dielectric waveguide 320, and most of the light continues on through the combined dielectric/nanowire system 310 (i.e., the dual-waveguide system). A small part is reflected back along the dielectric waveguide.

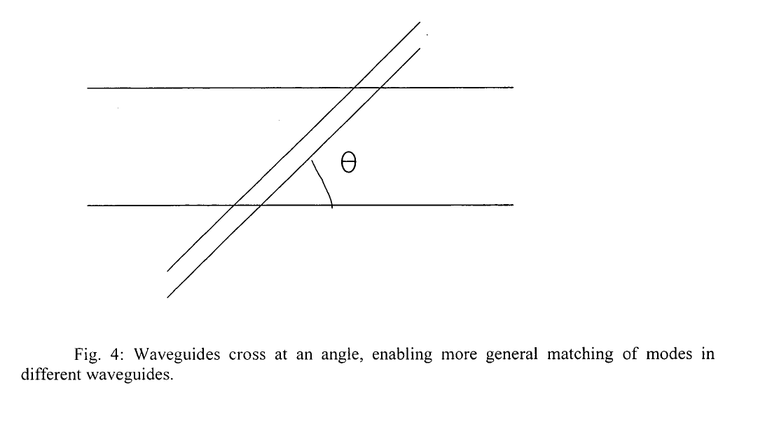

FIG. 2 illustrates a cross section of dual-core silver-dielectric configuration, the cross-sections of the individual waveguides are not necessarily circular. Moreover, as shown in FIG. 4, the waveguides 320, 330 can cross at an angle, enabling more general matching of modes in different waveguides.

The main constraint of the parallel waveguides described herein, which ensures resonant mixing of the dielectric and nanowire waveguide modes, is that the longitudinal wave number is nearly the same in the two waveguides 320, 330. However, these can be restrictive in the types of systems which are physically realizable. Accordingly, in accordance with an embodiment of the present invention, this constraint can be relaxed by creating dielectric and nanowire waveguides 320, 330 which cross at an angle (e.g., the crossed waveguides of FIG. 4). In order to get resonant transfer from the wide waveguide 320 to the narrow waveguide 330, the matching condition should be
β_{narrow}˜β_{wide}^{COS θ} (2)

It is appreciated that one waveguide, for example, is narrow, much smaller than any wavelength in the system. If this is not true, for example, the driven waveguide samples the driven mode at a wide range of phases, which can destructively interfere and impede mixing. Also the interaction length, the region where the two waveguides overlap, should be many wavelengths long, for example, or the mixing may be very weak. This may require the wide waveguide to be a slab waveguide.

Various embodiments of the present invention described herein can be compared using the following equation proposed by Benabid et al. for producing intense electric fields for non-linear optics:

$${f}_{om} = \frac{{L}_{int} λ}{{A}_{eff}} , \qquad ( 3 )$$

where Lᵢₙₜ is the length of the effective constant-intensity interaction region, λ is the wavelength of light, and A_{eff} is the effective cross-sectional area. For example, a laser beam focused by conventional optics has fₒₘ=16. Benabid et al. estimate that a HC-PCF with an attenuation of 5 dB/m and a 10 micron open core has fₒₘ=1600. As described herein, the dual-waveguide system 310 of the present invention has an interaction length of order 100 microns, a wavelength in the experimental region of 1.2 microns, and an effective area of 0.065 square microns, which results fₒₘ=1800.

In the embodiments and examples descried herein, all the vacuum wavelength of light has been assumed to be 885 nm. In an exemplary embodiment of the present invention, the dielectric waveguide 320 has a radius of 2 microns and an index of refraction of 1.401. The metallic nanowire 330 has a radius of 200 nm and a complex index of refraction of 0.163+5.95i. In accordance with an embodiment of the present invention, the distance between the center of the dielectric waveguide 320 and the center of the silver nanowire 330 is 2.7 microns which leaves a surface to surface gap of 0.5 microns. FIGS. 2 and 3 show the dual-core configuration in accordance with an embodiment of the present invention. The index of the refraction of the medium 340 in which the dielectric waveguide 320 and the silver nanowire 330 are embedded is 1.36, which is typical of organic solvents.

Table 1 shows the propagating modes of the dielectric waveguide 320 in isolation. Modes of isolated 2 micron radius dielectric core of index 1.401 in a surrounding medium 340 of index 1.36. The driving light source (i.e., the laser 100) has a wavelength of 885 nm in a vacuum.

TABLE 1

| MODE NUMBER | MULTIPLICITY | B(μ⁻¹) |
|---|---|---|
| 1 | 2 | 9.703259536 |
| 2 | 2 | 9.727448585 |
| 3 | 2 | 9.729166802 |
| 4 | 1 | 9.821637502 |
| 5 | 2 | 9.821945634 |
| 6 | 1 | 9.823266419 |
| 7 | 2 | 9.896837368 |

TABLE 2

| Mode number | Multiplicity | Reβ | Imβ |
|---|---|---|---|
| 1 | 2 | 9.89320505 | 0.0200313 |
| 2 | 1 | 10.3588468 | 0.0318249 |

It is appreciated that there are many modes because of the large contrast in indices of refraction. Table 2 shows the propagating modes of the silver nanowire 330 in isolation, modes of 0.2 micron radius silver nanowire 330 in a surrounding medium 340 in index 1.36. At a vacuum wavelength of 885 nm, silver has a complex index of refraction 0.163+5.95i. Since silver's index of refraction has a small real part, the longitudinal propagation constant β has a small imaginary part corresponding to the decay of the plasmon collective oscillation as it propagates down the nanowire 330. The multiplicity-2 mode of the nanowire 330 has angular dependence e^{±iθ}. The multiplicity-1 mode is invariant under rotations in θ. It is appreciated that Re(β) for the multiplicity-2 mode is close to the β of the fundamental mode of the dielectric waveguide. In fact, the difference in Re(β) is less than the difference in Im(β).

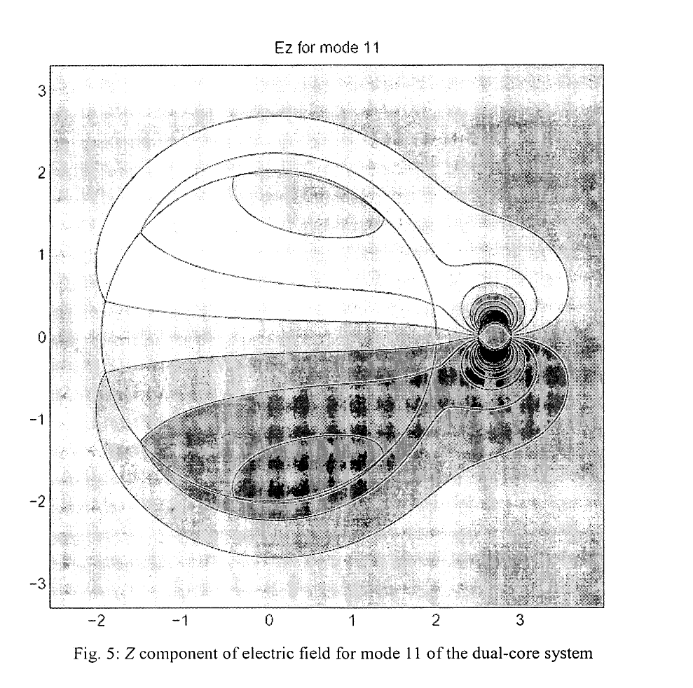

Table 3 shows the propagating modes of the dual-core system 310 of the present invention. The modes were calculated using a boundary integral method such as those proposed by H. Cheng et. al. A convergence study shows that the values shown in Table 3 are accurate to more than nine digits. The geometry of the two cores breaks the symmetry of the system 310 so all modes are multiplicity 1. The modes can be grouped into three families. Modes 1-10 are similar to the modes 1-6 of the dielectric waveguide 320. These modes do excite the plasmon oscillation on the nanowire 330 to some extent and thus have a non-zero Im(β), but the imaginary part is relatively small. Mode 15 is the analogue of the multiplicity-1 mode of the isolated nanowire 330. Modes 11-14 result from mixing of the dielectric waveguide 320 fundamental mode and the multiplicity-2 modes of the nanowire 330. The strongly mixed modes separate into two groups, one group with a decay distance of approximately 70 microns, and the other with a decay distance of 260 microns. All of these modes have a strong electric field in the vicinity of the silver nanowire 330. FIG. 5 shows the z component of the electric field for mode 11. The electric field decays rapidly inside the nanowire so the maximum field is achieved on its surface.

TABLE 3
Modes of Dual-Core System

| mode number | Reβ | Imβ |
|---|---|---|
| 1 | 9.695779665 | 0.000447618 |
| 2 | 9.698276461 | 0.000286397 |
| 3 | 9.721494591 | 0.000297673 |
| 4 | 9.723302067 | 0.000243051 |
| 5 | 9.728320615 | 0.000016346 |
| 6 | 9.728484646 | 0.000013195 |
| 7 | 9.814341515 | 0.001153377 |
| 8 | 9.817543743 | 0.000899248 |
| 9 | 9.821767085 | 0.000000913 |
| 10 | 9.822631476 | 0.000019844 |
| 11 | 9.893267602 | 0.003916224 |
| 12 | 9.895820210 | 0.003719213 |
| 13 | 9.899776809 | 0.014959894 |
| 14 | 9.907658628 | 0.014212918 |
| 15 | 10.359777941 | 0.031735636 |

Coupling between the two cores destroys any degeneracy of the modes. The fundamental mode of the dielectric waveguide 320 mixes strongly with the multiplicity-2 mode of the nanowire 330 to produce modes 11-14.

Turning now to FIG. 3, there is illustrated a side view of a dielectric waveguide 320 coupled to a nanowire 330 to form a dual-core or dual-waveguide system 310 of the present invention. For z<0 there is only a dielectric waveguide 320. In the region z>0 there are two cores, the dielectric waveguide 310 and the nanowire waveguide 330, preferably metallic nanowire waveguide 330. The dielectric waveguide 320 in z>0 is a continuation of the dielectric waveguide 320 in the z<0 region. The present invention poses a scattering problem in which a fundamental waveguide mode is incident from z<0. At z=0 it couples to forward traveling waves in the z>0 region and backward traveling waves in the z<0 region. The superposition of modes in the z>0 region include modes which produce large electric fields around the silver nanowire 330.

In each region, z<0 and z>0, the present invention represents the solution as a superposition of modes of the single-core and dual-core systems respectively. This ensures that the present invention constructs solutions to Maxwell's equations in each region. The mathematical problem is to find superpositions that satisfy Maxwell's equations on the plane z=0. On the plane z=0 Maxwell's equations specify that the tangential components of \vec{E} and \vec{H} are continuous, that is Eₓ, E_{y}, Hₓ, and H_{y}. Examination of Maxwell's equations shows that continuity of the normal components of \vec{D} and \overline{B} is implied by this boundary condition.

In the region z<0 (z>0), the k^{th} mode will have a longitudinal propagation constant βₖ^{<}(βₖ^{>}), modal functions for the \vec{E} fields [symbol] ₖ^{<}(X)( [symbol] ₖ^{>}), and modal functions for \vec{H} fields \overline{h}ₖ^{<}(X)(\overline{h}ₖ^{>}). The modes are labeled by k which takes on positive and negative values. The present invention negative k with left travelling modes and positive k with right travelling modes. Modes with index k and −k are related by
β₋ₖ=−βₖ (4)
e_{-k,z}=e_{k,z} (5)
e_{-k,t}=−e_{k,t} (6)
h_{-k,z}=−h_{k,z} (7)
h_{-k,t}=h_{k,t} (8)
where t indicates a transverse component, i.e. x or y. The modal functions have the property that different modes are orthogonal with the following inner product:

$$\int ⅆ A \{ {e}_{k} \times {h}_{- m} - {e}_{- m} \times {h}_{k} \} \cdot \hat{z} = \{ \begin{matrix}0 & if k \neq m \\ {N}_{k} & if k = m\end{matrix} \qquad ( 9 )$$

where the integral is over the x, y plane. It is appreciated that the inner product does not involve complex conjugation.

For example, assume that mode k is incident from the left. In the region z<0, the present invention represents the scattering solution to Maxwell's equations as an incident right moving mode plus a sum over left moving modes

$$( \begin{matrix}{\vec{E}}^{<} ( \vec{x} , z ) \\ {\vec{H}}^{<} ( \vec{x} , z )\end{matrix} ) = {ⅇ}^{ⅈ {β}_{k}^{<} z} ( \begin{matrix}{\vec{e}}_{k}^{<} ( \vec{x} ) \\ {\vec{h}}_{k}^{<} ( \vec{x} )\end{matrix} ) + {\sum }_{n > 0} {a}_{- n}^{<} {ⅇ}^{- ⅈ {β}_{n}^{<} z} ( \begin{matrix}{\vec{e}}_{- n}^{<} ( \vec{x} ) \\ {\vec{h}}_{- n}^{<} ( \vec{x} )\end{matrix} ) . \qquad ( 10 )$$

In the region z>0, only the left moving modes are present:

$$( \begin{matrix}{\vec{E}}^{>} ( \vec{x} , z ) \\ {\vec{H}}^{>} ( \vec{x} , z )\end{matrix} ) = {\sum }_{n > 0} {a}_{n}^{>} {ⅇ}^{ⅈ {β}_{n}^{>} z} ( \begin{matrix}{\vec{e}}_{n}^{>} ( \vec{x} ) \\ {\vec{h}}_{n}^{>} ( \vec{x} )\end{matrix} ) . \qquad ( 11 )$$

The scattering problem is to find coefficients aₙ^{>} and aₙ^{<} such that the two Maxwell boundary conditions are fulfilled:
Eₜ^{<}(\vec{x}, 0)=Eₜ^{>}(\vec{x}, 0) (12)
Hₜ^{<}(\vec{x}, 0)=Hₜ^{>}(\vec{x}, 0) (13)
where t is a transverse index, i.e. x or y.

The sums in equations (10) and (11) formally include all modes: propagating, and radiation. Generally, information is available only on the 12 modes of the dielectic waveguide and the 15 modes of the dual-core system. Therefore, equations (12) and (13) can be approximately solved. In accordance with an embodiment, the present invention solves equations (12) and (13) in the least squares sense by formatting an objective function

$$I ( {a}^{>} , {a}^{<} ) = {\sum }_{i , t} {ε}_{0} {\vert {E}_{t}^{<} ( \vec{{x}_{i}} ) - {E}_{t}^{>} ( \vec{{x}_{i}} ) \vert}^{2} + {μ}_{0} {\vert {H}_{t}^{<} ( \vec{{x}_{i}} ) - {H}_{t}^{>} ( \vec{{x}_{i}} ) \vert}^{2} \qquad ( 14 )$$

where t runs over x and y, xᵢ is a set of points in the z=0 plane. ε₀ and μ₀ are inserted into the objective function so that all terms have the same units. It is appreciated that this is a least squares problem with 27 unknowns, the coefficients a^{<} and a^{>}. The number of equations should be much greater than 27. In accordance with an embodiment, the present invention uses arrays of either 57,000 points or 115,000 point in the z=0 plane arranged in a regular grid. The condition number of the resulting matrix is O(10), so it is easy to solve. The value of I at its minimum is a measure of how accurately the scattering problem is solved and √I is about 2% of the norm of the incident field in the present invention. The error is concentrated at the surface of the metallic nanowire 330 and can be caused by the omission of radiation states from the sums in equations (10) and (11). The results are insensitive to the number or location of the points \vec{x}ᵢ. Changing the number of points from 57,000 to 115,000 changed the coefficients a^{<} and a^{>} in their third significant figure.

In accordance with an exemplary embodiment, the present invention analyzes the case where the incident field is proportional to the fundamental HE11 mode of the fiber. This mode has two possible polarizations. It is convenient to choose polarizations which are eigenfunctions under reflection y→−y. However the results are not greatly changed by the choice of the input polarization and the results are ones shown for the polarization which changes the sign of E_{z}, under reflection in y.

TABLE 4
Forward Scattering Coefficients

| mode | | | | |
|---|---|---|---|---|
| number | Re(β) | Im(β) | Re(a^{>}) | Im(a^{>}) |
| 1 | 9.695779665 | 0.000447618 | 0.0000000 | 0.0000000 |
| 2 | 9.698276461 | 0.000286397 | −0.0052502 | 0.0003717 |
| 3 | 9.721494591 | 0.000297673 | 0.0000000 | 0.0000000 |
| 4 | 9.723302067 | 0.000243051 | 0.0056393 | −0.0003489 |
| 5 | 9.728320615 | 0.000016346 | −0.0010067 | 0.0000256 |
| 6 | 9.728484646 | 0.000013195 | 0.0000000 | 0.0000000 |
| 7 | 9.814341515 | 0.001153377 | 0.0000000 | 0.0000000 |
| 8 | 9.817543743 | 0.000899248 | −0.0221737 | 0.0036458 |
| 9 | 9.821767085 | 0.000000913 | 0.0000000 | 0.0000000 |
| 10 | 9.822631476 | 0.000019844 | −0.0032165 | 0.0000357 |
| 11 | 9.893267602 | 0.003916224 | 0.0000000 | 0.0000000 |
| 12 | 9.895820210 | 0.003719213 | −1.1275739 | −0.0878212 |
| 13 | 9.899776809 | 0.014959894 | −0.1787575 | 0.5402551 |
| 14 | 9.907658628 | 0.014212918 | 0.0000000 | 0.0000000 |
| 15 | 10.359777941 | 0.031735636 | 0.0000000 | 0.0000000 |

Tables 4 and 5 show the modal coefficients for the approximate scattering solution. It is appreciated that roughly half of the forward scattering coefficients are exactly zero. This is expected because the dual mode geometry is invariant under y→−y so the modes are also eigenmodes of the reflection operation. Modes with positive parity cannot mix with the incident mode which was chosen to have negative parity. Note also that the only modes with appreciable weight in the forward or backward scattering modes are modes 12 and 13 in the forward modes. Almost all the incident wave passes through the interface.

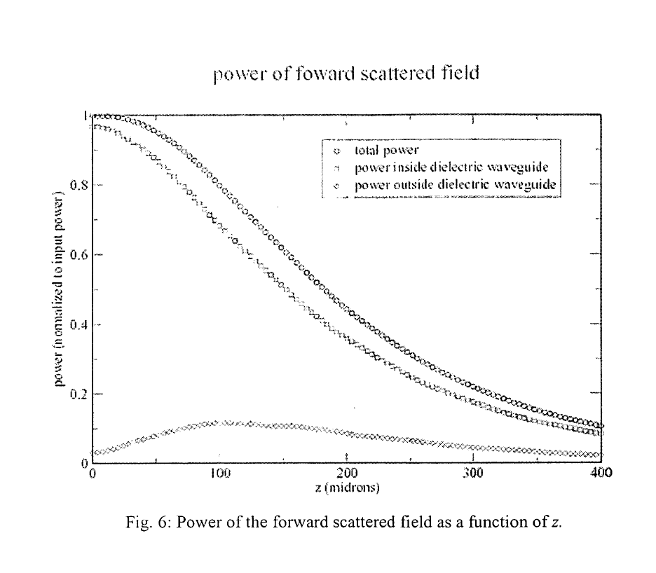

Using these coefficients, an embodiment of the present invention forms the approximate forward scattered E and H field by substitution into equation (11), and compute functions of the field as a function of z. Turning now to FIG. 6, there is illustrated a time averaged power integrated over the xy plane as a function of z. The power decays with increasing z because all of the dual-core modes, and modes 12 and 13 in particular, are dissipative. It is appreciated that the majority of the power is contained within the dielectric waveguide 320.

FIG. 5 shows the maximum magnitude of the electric field as a function of z. At z=0 the magnitude in the interior of the dielectric waveguide 320 is much larger than the field outside the dielectric waveguide 320. But the maximum field intensity outside the dielectric waveguide 320 grows by almost a factor of 10 before it begins to decline. For non-linear processes where efficiency grows by the square of the magnitude, this can be important.

As described herein, the non-linear processes depend on integrals of the fourth power of the electric field. In accordance with an embodiment, the present invention develops an estimate of the effective area in which the non-linear processes are active by defining an effective area as

$${A}_{eff} ( z ) = \frac{\int ⅆ A {\vert \vec{E} ( x , y , z ) \vert}^{4}}{max {\vert E \vert}^{4}} \qquad ( 15 )$$

TABLE 5
Backward Scattering Coefficients

| mode number | Re(β) | Im(β) | −Re(a^{<}) | −Im(a^{<}) |
|---|---|---|---|---|
| 1 | −9.703259536 | 0.000000000 | −0.0003904 | 0.0000038 |
| 2 | −9.703259536 | 0.000000000 | −0.0000252 | 0.0000002 |
| 3 | −9.727448584 | 0.000000000 | 0.0000004 | 0.0000000 |
| 4 | −9.727448584 | 0.000000000 | −0.0002676 | 0.0000027 |
| 5 | −9.729166802 | 0.000000000 | 0.0000046 | 0.0000000 |
| 6 | −9.729166802 | 0.000000000 | −0.0002810 | 0.0000023 |
| 7 | −9.821637502 | 0.000000000 | 0.0000000 | 0.0000000 |
| 8 | −9.821945634 | 0.000000000 | −0.0001070 | 0.0000011 |
| 9 | −9.821945634 | 0.000000000 | −0.0000859 | 0.0000009 |
| 10 | −9.823266419 | 0.000000000 | −0.0001291 | 0.0000008 |
| 11 | −9.896837368 | 0.000000000 | −0.0000257 | 0.0000002 |
| 12 | −9.896837368 | 0.000000000 | −0.0000580 | 0.0000003 |

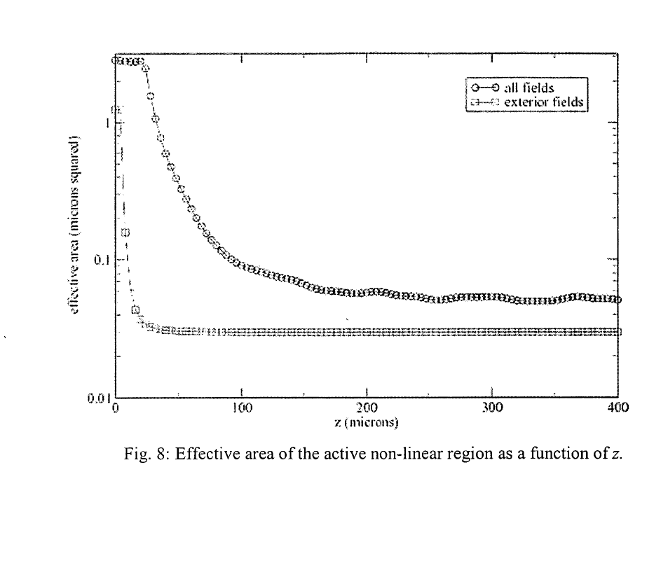

Turning now to FIG. 8, there is illustrate a chart which shows the effective area as a function of z. At z=150 microns, the effective area is 0.065 square microns. If the integration is restricted to the region outside the dielectric waveguide 320, the effective area is 0.03 square microns.

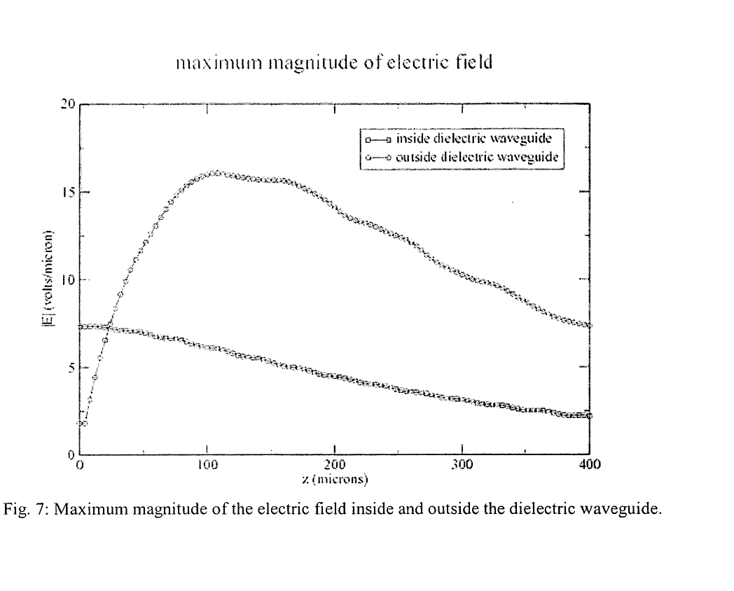

In certain applications, it is important to understand how intense the electric field can be made before the dual-waveguide system or device 310 fails. In accordance with an embodiment of the present invention, one limitation of the dual-waveguide system 310 is shown in FIG. 7, which shows that a one Watt laser intensity produces fields of order 10⁷ Volts/meter. It is appreciated that this is near the breakdown field for atoms, so instaneous intensities should be limited to the one Watt level. There is however a more restrictive limitation on the average power of the input laser 100.

As the chart in FIG. 6 illustrates, energy is dissipated in the dual-core system 310. It is appreciated that all of the power dissipation occurs in the metallic nanowire 330, in a region measuring 100's of nanometers in length. The operation of the dual-waveguide system 310 will cease if the dissipated energy melts the nanowire 330 or raises the sample medium 340 above its boiling point.

The physical situation is that energy is deposited in a small region near the surface of the metallic nanowire 330. Thermal energy is then conducted outward through the sample medium 340 and down the axis of the nanowire through the metallic nanowire 330. Heat can also be advected away from the nanowire 330 by convection, but the present invention ignores the cooling arising from that mechanism to address the worst case scenario. The problem is then to calculate the temperature distribution on the nanowire 330 arising from a given energy deposition distribution.

Although this problem can be solved without approximation, it is not necessary because the present invention is concerned with an order of magnitude estimates. First, the present invention assumes that the metallic nanowire 330 is infinite in extent. This is unlikely to change the results drastically because the rate of energy deposition is zero at the beginning of the nanowire 330. Second, the present invention ignores the thermal conductivity of the metallic nanowire 330. More careful estimates show that the metallic conductivity does not even change the first significant figure of the result. Now in accordance with an embodiment of the present invention employs a separation of variables:

$$\begin{matrix}T ( r , z ) = \int ⅆ k {ⅇ}^{ⅈ k z} ϕ ( r ; k ) & ( 16 ) \\ where ϕ ( r ; k ) satisfies & \\ \frac{1}{r} \frac{\partial }{\partial r} ( r \frac{\partial ϕ}{\partial r} ) - {k}^{2} ϕ ( r ; k ) = 0. & ( 17 )\end{matrix}$$

Clearly φ is proportional to a modified Bessel function of 0^{th} order.
φ(r; k)=bₒᵤₜK₀(kr) (18)

The coefficient bₒᵤₜ, is determined by the requirement that heat conduction outward through the surface of the metallic nanowire match the power deposited there:

$${b}_{out} ( k ) = {( \frac{ⅆ P}{ⅆ z} )}_{k} \frac{1}{2 π a {α}_{out} \frac{\partial }{\partial r} {K}_{0} ( k r )} \qquad ( 19 )$$

where a is the radius of the nanowire 330 and αₒᵤₜ is the thermal conductivity of the exterior medium 340. If the energy is deposited in a region of size Δ, then the dominant contribution in the integral (13) will be when k˜2π/Δ. Therefore the quantity ka is small and K₀(kr) is well approximated by the first term in its logarithmically divergent expansion. Therefore

$${b}_{out} ( k ) ∼ \frac{1}{2 π {α}_{out}} {( \frac{ⅆ P}{ⅆ z} )}_{k} \qquad ( 20 )$$

If P₀ is the initial power of the input, and it is dissipated in a region Δ, then dP/dz is roughly P₀/A. This leads to a estimate that peak temperatures on the nanowire 330 are

$$T ∼ \frac{{P}_{0}}{Δ} \frac{1}{2 π {α}_{out}} ( - log \frac{k a}{2} ) \qquad ( 21 )$$

or roughly 10⁴ to 10⁵ K for a 1 Watt input. This means that average beam power needs to be down around a milli-Watt. Alternatively, the beam could be pulsed and have higher peak power than average power.

If a oscillating current \vec{J} is flowing within a bounded region of a waveguide it induces electromagnetic waves to radiate from that region. Let the electric and magnetic fields be expanded in a modal expansion over right and left travelling waves:

$$( \begin{matrix}\overline{E} ( \overline{x} , z ) \\ \overline{H} ( \overline{x} , z )\end{matrix} ) = {\sum }_{n > 0} {α}_{n} {ⅇ}^{{ⅈθ}_{j} z} ( \begin{matrix}{\overline{e}}_{n} ( \overline{x} ) \\ {\overline{h}}_{n} ( \overline{x} )\end{matrix} ) + {α}_{- n} {ⅇ}^{- {ⅈθ}_{j} z} ( \begin{matrix}{\overline{e}}_{- n} ( \overline{x} ) \\ {\overline{h}}_{- n} ( \overline{x} )\end{matrix} ) . \qquad ( 22 )$$

Following the notation of Synder et al., in accordance with an embodiment, the modal expansion coefficients as

$${α}_{j} ( z ) = {α}_{j} ( {z}_{0} ) + \frac{1}{{N}_{j}} {\int }_{{z}_{0}}^{z} ⅆ {z}^{′} \int ⅆ A \overline{J} ( \overline{x} , z ) \cdot {e}_{- j} ( \overline{x} ) {ⅇ}^{- {ⅈθ}_{j} z} \qquad ( 23 )$$

where Nⱼ is the normalization previously defined.

In accordance with an exemplary embodiment of the present invention, the case where \vec{J} arises from a single molecule. In this exemplary case, the modal dependence from the integral can be removed. In accordance with an embodiment, the present invention can use standard manipulations to convert the integral over \vec{J} into the electric dipole moment \vec{p}:

$${α}_{j} ( z ) = {α}_{j} ( {z}_{0} ) + \frac{1}{{N}_{j}} ( - ⅈω ) \overline{p} \cdot {e}_{- j} ( {x}_{0} ) {ⅇ}^{- {ⅈθ}_{j} {z}_{0}} . \qquad ( 24 )$$

In accordance with an exemplary embodiment, the present invention is concerned with the dipole moments which are induced in the molecule by being exposed to another electric field. The constant of proportionality which relates dipole moment to field strength is called polarizability:
\vec{p}=\overline{α}\overline{E}. (25)

The polarizability consists of a constant plus oscillating terms corresponding to the vibrations and rotations of the molecule.

$$\overline{α} = {\overline{α}}_{0} + {\sum }_{n > 0} {\overline{α}}_{n}^{′} cos {ω}_{n} t \qquad ( 26 )$$

The constant \overline{α}₀ causes elastic scattering of light and will not be of further interest. The oscillating terms proportional to z,999 ₙ, cause Raman-shifted scattering of light. The Raman-scattered light will have frequency ω′=ω±ωₙ. In the following it should be understood that the modal expansions are modes for a Raman-shifted frequency ω′.

For simplicity assume that the modal intensity at z₀ is zero.

$${α}_{j} ( z ) = \frac{1}{{N}_{j}} ( - ⅈω ) \overline{E} ( {\overline{x}}_{0} , {z}_{0} ) \cdot {\overline{α}}^{′} \cdot {e}_{- j} ( {\overline{x}}_{0} ) {ⅇ}^{- {ⅈθ}_{j} {z}_{0}} . \qquad ( 27 )$$

The power in the j^{t}h mode from Raman scattering from a single molecule is

$$\begin{matrix}{P}_{j} ( z ) {\vert {α}_{j} \vert}^{2} = \frac{{P}_{j} ( z )}{{N}_{j}^{2}} {ω}^{2} {\vert {ⅇ}^{- {ⅈθ}_{j} {z}_{0}} \vert}^{2} {\vert {e}_{- j} ( {x}_{0} ) \cdot {\overline{α}}^{′} \cdot \overline{E} ( {x}_{0} , {z}_{0} ) \vert}^{2} \\ where & ( 28 ) \\ {P}_{j} ( z ) = {ⅇ}^{- 2 z I m ( {θ}_{j} )} \int ⅆ A Re ( {\overline{e}}_{j} \times {\overline{h}}_{j} ) \cdot z & ( 29 )\end{matrix}$$

Many molecules are assumed to be scattered from with a number density N/V. The single molecule polarizability is assumed to average to a scalar which can be extracted. Their scattered powers add incoherently to yield

$${ω}^{2} \frac{N}{V} {α}^{2} \frac{{P}_{j} ( 0 )}{{N}_{j}} {ⅇ}^{- 2 zIm ( {θ}_{j} )} {\int }^{x} ⅆ z \int ⅆ A {\vert {ⅇ}^{- {ⅈθ}_{j} z} {\overline{e}}_{j} ( x ) \cdot \overline{E} ( x , z ) \vert}^{2} \qquad ( 30 )$$

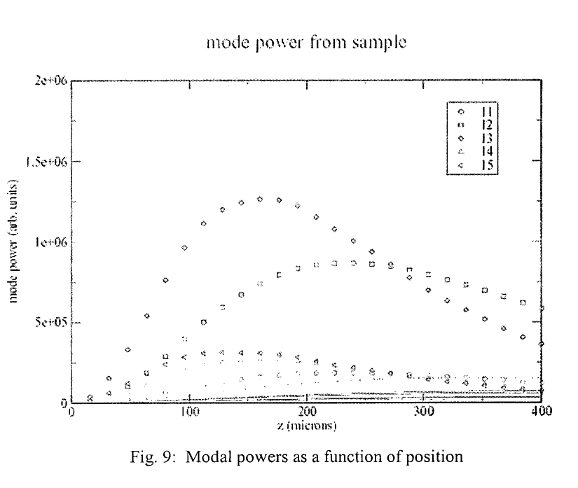

In accordance with an embodiment, the present invention can now evaluate equation (30) to find the power in each mode created by Raman scattering from sample molecules. \vec{E}(x,z) is the electric field computed herein. The Raman shift is assumed small enough that the present invention can use the modal wavefunctions previously computed herein. In the chart of FIG. 9, the power in the modes of the dual-core system 310 as a function of z arising only from molecules outside the dielectric waveguide 320 (the sample region). The units are arbitrary since a prefactor of ω²Nα²/V has been removed. The chart in FIG. 9 shows that most of the power arising from molecules outside the dielectric waveguide 320 are found in modes with large fields near the metallic nanowire 330.

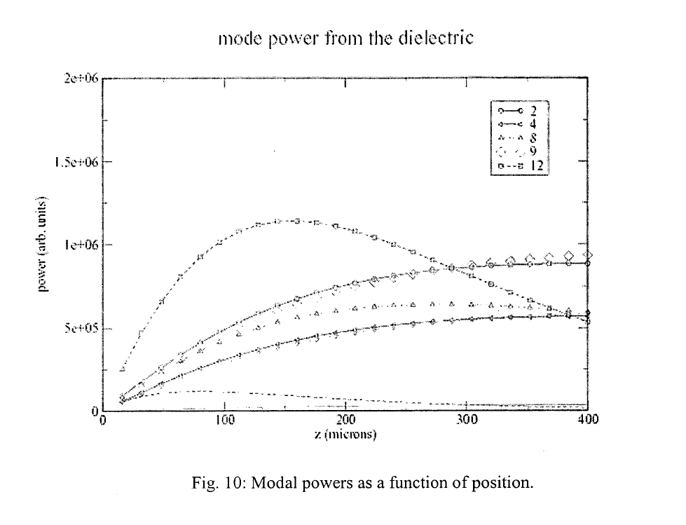

Turning now to FIG. 10, there is illustrate a chart showing the power in the modes of the dual-core system 310 arising from molecules inside the dielectric waveguide 320. At small z, the predominant mode is one of the highly mixed modes. But at larger z, the unmixed modes which have small Im(β) become dominant. Although the units are arbitrary, FIGS. 9 and 10 can be compared if the number density N/V and the polarizability of the molecules inside and outside the waveguide 320 are the same.

It is appreciated that the present invention is not restricted to circular dielectric waveguides 320 or circular nanowires 330. Accordingly, the present invention can be used with planar light wave circuits where the dielectric waveguides 320 and nanowires 330 are trapezoidal in cross-section. If the background noise from Raman excitations of device material (i.e., anything but the sample medium 340) is a problem, then a planar waveguide 320 or nanowire 330 can be a problem if it is sitting on top of the problem material. In that case, the waveguides/nanowires 320, 330 should be supported above the substrate.

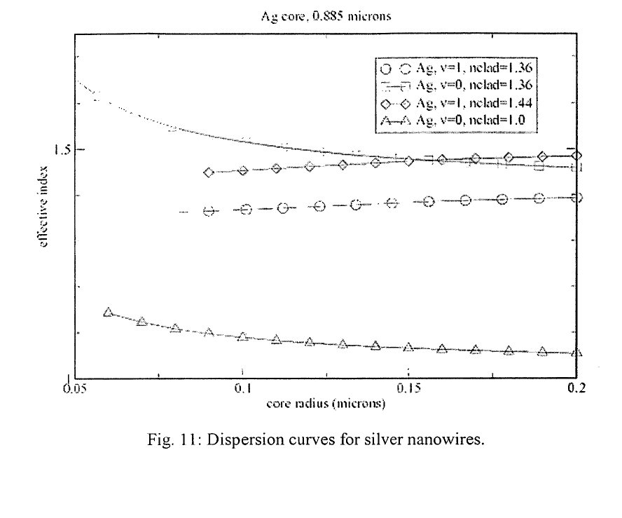

In accordance with an embodiment of the present invention, the dual-waveguide system 310 comprises nanowires 330 and dielectric waveguides 320 that have the same ω and the same β. Turning now to FIG. 11, there is illustrated a chart showing dispersion curves for the silver nanowires 330. The effective index of refraction, n_{eff}=β/k₀, is graphically displayed as a function of the radius of a silver nanowire 330 at 885 mm. Although, the present invention have been described herein, where the nanowire 330 has v=1 plasmon excitations with a cladding index of 1.36, the present invention is not limited to such nanowires. For example, a nanowire with v=0 plasmon excitations can be also used as long as the resonant effective index of refraction n_{eff} is increased to 1.46 or greater. It is appreciated however that the dielectric waveguide 320 can have many modes. Even if nanowire 330 with v=0 is used, it is appreciated that the effective index can be unrealizably small. In accordance with an embodiment of the present invention, the dual-waveguide system 310 of the present invention can be used with a solid sample medium, e.g., a solid-state Raman amplifier.

In accordance with an embodiment of the present invention, the resonance can be achieved with the dual-waveguide system 310 even if β's don't match by varying another parameter, such as an angle of crossing. The waveguides 320, 330 discussed herein were generally parallel and the waveguide widths were both on the scale of a micron. In accordance with an aspect of the present invention, the waveguides 320, 330, particularly in a planar lightwave circuit, can cross at an angle. There will be appreciable energy transfer if the two waveguides overlap for a distance of many wavelengths. Given a non-zero intersection angle θ and a narrow nanowire 330 as shown in FIG. 4, this can be realized if the dielectric waveguide 320 is wide, i.e., a slab waveguide. A simple physical argument tells us that we will get resonant matching if
λₘₑₜₐₗ=λ_{dielectric} cos θ (31)
where λᵢ is the wavelength of the i^{th} waveguide. This is useful in matching a high-index dielectric medium to a low-effective-index metallic medium (see FIG. 11). For non-zero crossing angles (see FIG. 4), energy extraction is generally weaker than the parallel waveguide case (see FIGS. 2 and 3) because the overlap region will be shorter. However, in accordance with an embodiment of the present invention, the crossing waveguides advantageously permits the use of an array of nanowires 330, each tuned to a different chemical or with different coatings. This advantageously permits the Raman sensor 300 to detect a plurality of chemicals. It is appreciated that the low energy transfer can be compensated by increasing the power of the input beam, i.e., the laser 100.

In accordance with an embodiment of the present invention, the intensity of the electric field near the nanowire 330 can increased by making the nanowire 330 thinner. However, changing the radius of the nanowire 330 changes the effective index of refraction n_{eff}. Accordingly, the appropriate dimensions or elements of the nanowire 330 can be selected based on the dispersion curves of FIG. 11 and realizable materials. In accordance with an aspect of the present invention, the intensity of the electric field the nanowire 330 can be increased by putting corners on the nanowire 330.

The calculations described herein relates to the transition of the light from single-core to double core, but it is appreciated that one of ordinary skill in the art can calculate the transition back to single core based on the disclosure herein. The calculation should be relatively efficient because the majority of the power remains in the dielectric waveguide 320 even in the heavily mixed modes.

In accordance with an embodiment of the present invention, the Raman spectroscopy 10 comprises filters 200, 400, preferably band-pass filters, to filter out the background noise coming from Raman emissions in the dielectric waveguide 320. In accordance with an aspect of the present invention, the light from the laser 100 is band-pass filtered by the filter 200 before entering the Raman sensor 300 to eliminate or minimize the silica Raman emissions. Accordingly, the light needs to get into the Raman sensor 300 before the light picks up new Raman emissions. The large effective mode area of typical fiber optic waveguide assists in this process. Additionally, the light leaving the Raman sensor 300 is filtered by the filter 400 to eliminate or minimize the direct signal.

In accordance with an embodiment of the present invention, the dual-waveguide system 310 is constructed such that the energy transfers a dielectric optical waveguide 320 to a nanowire waveguide 330, preferably a metallic nanowire waveguide 330, which can support a plasmon propagating mode. A required condition for such energy transfer is that the two waveguides 320, 330 have propagating modes with the same longitudinal wavenumber β at the same frequency ω. However, depending on the waveguide materials and the index of the surrounding medium 340, it may not always be possible to find matching modes, or the only matching modes are unsatisfactory for some reason. In such case, the dual-waveguide system 310 can be constructed using other geometries with different matching conditions.

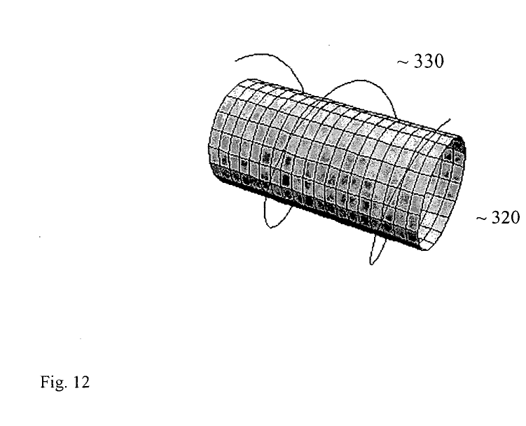

Turning now to FIG. 12, there is illustrated a dual-waveguide system 310 in accordance with an embodiment of the present invention wherein a central straight dielectric optical waveguide 320 is enclosed by a nanowire waveguide 330, preferably a metallic nanowire waveguide 330, which wraps around the straight dielectric waveguide 320 in a helical path. Unlike the dielectric optical waveguide 320, the nanowire waveguide 330 can assume a curved path without radiating large fractions of any electromagnetic mode it carries. The matching condition for resonance between the two waveguides 320, 330 is βₚₗₐₛ times the square root of 1+(2πr/L)² equals β_{diel} where βₚₗₐₛ is the longitudinal wavenumber of the plasmon mode in the nanowire waveguide 330, r is the radius of the helix, L is the pitch of the helix, and β_{diel} is the longitudinal wavenumber of the dielectric waveguide 320. By adjusting the pitch of the helix, the dual-waveguide system 310 tune the matching condition over a broad range, subject to the constraint that the wavelength in the dielectric 320 is shorter than the wavelength of the plasmon mode in the nanowire 330.

Having now described a few embodiments of the invention, it should be apparent to those skilled in the art that the foregoing is merely illustrative and not limiting, having been presented by way of example only. Numerous modifications and other embodiments are within the scope of ordinary skill in the art and are contemplated as falling within the scope of the invention.

1. A dual-waveguide system, comprising:
a transparent dielectric waveguide; and
a nanowire waveguide located in proximity to said dielectric waveguide, wherein said nanowire waveguide supports plasmon excitations and is resonantly coupled to said dielectric waveguide such that said dielectric waveguide resonantly drives plasmon oscillations on said nanowire waveguide.

2. The dual-waveguide system of claim 1, wherein said nanowire waveguide is parallel with said dielectric waveguide.

3. The dual-waveguide system of claim 1, wherein said nanowire waveguide crosses said dielectric waveguide at a non-zero angle.

4. The dual-waveguide system of claim 1, wherein said nanowire waveguide is a metallic waveguide.

5. The dual-waveguide system of claim 1, wherein said nanowire waveguide wraps around said dielectric waveguide in a helical path.

6. The dual-waveguide system of claim 1, wherein said dielectric waveguide resonantly drives plasmon oscillations on said nanowire waveguide when said dielectric waveguide is driven by a laser.

7. The dual-waveguide system of claim 1, wherein cross-sectional dimensions of said nanowire waveguide and said dielectric waveguide satisfies the following condition

|Re(β_{dieletric}ββ_{nanowire})|<Im(β_{nanowire})
to maximize the coupling of said dielectric waveguide to said nanowire waveguide.

8. The dual-waveguide system of claim 1 for use with Raman sensor, further comprising a fluid medium for embedding said dielectric waveguide and said nanowire waveguide.

9. The dual-waveguide system of claim 8 for use with Raman spectroscopy, further comprising laser for driving said dielectric waveguide, a first filter for filtering light from said laser before entering said Raman sensor, and a second filter for filtering light exiting said Raman sensor.

10. A method for resonantly driving plasmon oscillations on a nanowire waveguide, comprising the steps of:
driving a transparent dielectric waveguide at one end by a laser; and
resonantly coupling said nanowire waveguide to said dielectric waveguide such that said dielectric waveguide resonantly drives plasmon oscillations on said nanowire waveguide.

11. The method of claim 10, further comprising the step of driving said dielectric waveguide by a laser to resonantly drive plasmon oscillations on said nanowire waveguide.

12. The method of claim 10, wherein the step of resonantly coupling comprises the step of adjusting cross-sectional dimensions of at least one of the following: said nanowire waveguide and said dielectric waveguide.

13. The method of claim 12, wherein the step of adjusting comprising the step of adjusting said cross-sectional dimensions to satisfy the following condition

|Re(β_{dieletric}˜β_{nanowire})|<Im(β_{nanowire})
to maximize the coupling of said dielectric waveguide to said nanowire waveguide.

14. The method of claim 10, further comprising the step of embedding said dielectric waveguide and said nanowire waveguide in a fluid medium.

15. The method of claim 14, wherein the step of resonantly coupling comprises the step of adjusting the index of refraction of said fluid medium.

16. The method of claim 10, wherein the step of resonantly coupling comprises the step of selecting material of said nanowire waveguide to adjust the index of refraction of said nanowire waveguide.

17. The method of claim 16, wherein said nanowire waveguide is a metallic nanowire waveguide; and wherein the step of selecting material selects from one of the following: silver, gold and copper.

18. The method of claim 10, wherein the step of resonantly coupling by selecting said dielectric waveguide and said nanowire waveguide to support modes having substantially same frequency co and same longitudinal propagation constant β.

19. A method for transferring energy from a dielectric optical waveguide to nanowire waveguide, comprising the steps of:
driving a dielectric optical waveguide at one end by a laser; and
resonantly coupling said nanowire waveguide to said dielectric waveguide such that said dielectric optical waveguide resonantly drives plasmon oscillations on said nanowire waveguide to transfer energy from said dielectric optical waveguide to said nanowire waveguide.

20. The method of claim 19, wherein the step of resonantly coupling comprises the step of adjusting dimensions of at least one of the following: said nanowire waveguide and said dielectric optical waveguide.
